(19) United States
(12) Patent Application Publication
(10) Pub. No.: US 2024/0294213 A1
(43) Pub. Date: Sep. 5, 2024

(54) Structural Component

(71) Applicant: Weber Fibertech GmbH, 88677 Markdorf (DE)

(72) Inventor: Björn SONNENSTÄDT, Markdorf (DE)

(21) Appl. No.: 18/588,412

(22) Filed: Feb. 27, 2024

(30) Foreign Application Priority Data
Mar. 2, 2023 (DE) 20 2023 100 994.8

(51) Int. Cl. B62D 29/04

(52) U.S. Cl. CPC B62D 29/043

(57) ABSTRACT

A structural component for use in a vehicle, wherein the structural component (10) is made of a plastic material and is reinforced with a fiber collective (8) in the region of a narrow side, wherein the fiber collective (8) comprises random fibers.

The invention relates to a structural component for use in a vehicle, in particular in a motor vehicle, and to a method for producing such a structural component.

Structural components are used in many areas and are regularly used to absorb and transmit mechanical forces. They can also be used to connect other components to one another. In many cases, the aim is to provide a structural component with both high rigidity and low weight. This is particularly important in the field of lightweight construction, which is proving increasingly advantageous and is being used more and more frequently in many areas of technology.

Vehicles, in particular motor vehicles, can also be made lighter and more stable by using such structural components, without having to sacrifice comfort and safety.

In the automotive sector, the use of structural components helps to reduce CO₂ emissions, for instance. In this area, structural components are used to protect parts and assemblies. For example, flat, fiber-reinforced structural components can be used on the underside of a vehicle and thus serve as underbody protection.

The publication DE 10 2017 110 906 A1 describes a structural component that is in particular designed for use in a vehicle body. The structural component has a first structural element which at least partially encloses a spatial region, so that a cavity is formed inside the first structural element. This first structural element has a surface region delimiting this cavity and a second structural element. Furthermore, a reinforcing element is provided which serves for mechanical reinforcement of the first structural element.

Comparable structural components or structural elements, such as body components for passenger cars, are regularly made from metallic materials. However, it should be noted that these have a higher weight and higher production costs compared to plastic materials. They also tend to corrode.

Structural components serve to protect the occupants in the event of a collision, e.g. in the event of a frontal or side impact. In this case, structural elements must not splinter off or come loose, as this could endanger both the occupants and people in the area of impact. Especially thin-walled elements, which are in the area of impact, tend to splinter and fragment. It is important that fragments must not come loose, as they could otherwise endanger the occupants.

It should also be noted that in the case of metal components, the cohesion of possible elements which could splinter is sometimes secured with additional catch straps made of sheet steel.

For this reason, it is difficult to use plastics in the structure of a vehicle, e.g. as body components. This applies in particular to brittle plastics with glass fibers or carbon fibers, as these tend to splinter under extreme conditions.

However, as a material, plastic has the potential to be used in lightweight construction and at the same time save production costs and reduce weight.

A fiber composite component which is designed as a paintable motor vehicle body part is known from the publication DE 199 58 805 B4. This component comprises a cover layer made of a random fiber fleece embedded in a matrix system. This means that the component has a cover layer with a random fiber fleece on one long side to ensure that the entire component surface has an irregular ripple distribution with a defined ripple depth.

Against this background, a structural component according to claim 1 and a method for producing a structural component with the features of claim 11 are presented. Embodiments are apparent from the dependent claims and from the description.

A structural component for use in a vehicle is presented, wherein the structural component is made of a plastic material and is reinforced with a fiber collective in the region or a section of a narrow side of the structural component, wherein the fiber collective comprises random fibers.

Random fibers are fiber collectives whose individual fibers or fiber bundles do not have a preferred orientation. The fibers are present in these collectives in a random scattered position or a random position. The alignment of the fibers is thus disordered.

Until now, such random fibers have been used, for example, for pulp products such as cigarette paper and other specialty papers.

Furthermore, the structural component may have a thick-walled region and a thin-walled region, wherein the thin-walled region, which is provided at a narrow side of the structural component, is reinforced with the fiber collective comprising the random fibers.

The proposed structural component thus makes it possible to use plastic parts, and in particular thin-walled elements on plastic parts, in the vehicle structure as structural parts. Of course, the structural component can also be installed at other locations in the vehicle or be provided for other purposes in the vehicle.

The structural component can, for example, be reinforced with the random fibers in at least one edge region. These edge regions are exposed to external influences in particular and in many cases there is not enough installation space to use an appropriately dimensioned structural component which is also sufficiently stable in one or the edge regions. Since the presented structural component can be reinforced in the critical regions by the random fibers, this structural component can be dimensioned smaller in particular in these critical regions, even though the necessary mechanical stability exists.

For example, the structural component can be used as a body component for a vehicle, wherein a reinforcement or semi-finished product made of random, in particular long fibers is provided in thin-walled regions, e.g. in the case of wings or ribs. However, the use as a body component is only mentioned here as an example and is not intended to represent a limitation.

Due to their toughness and cross-linked connection, the random, in particular long fibers in themselves prevent the splintering of the reinforced, in particular thin-walled region and in this way also the splintering off of pieces of the in particular thin-walled region under very high loads, such as in the event of a frontal impact or side impact of the vehicle.

The random, in particular long fibers also connect the reinforced, in particular thin-walled region with the typically larger regions or parts of the actual structural component and thus prevent the reinforced region from detaching from the actual structural component, in particular even under very high loads, such as a frontal impact or a side impact of the vehicle.

It should also be noted that the random, in particular long fibers increase the strength and stiffness of the entire component.

In addition, very thin, stable extremities, such as ribs or wings, which can withstand high loads, such as the closing of a vehicle deck, can be realized on the structural component in this way.

In one embodiment, at least some of the random fibers have a length of up to 20 mm. In another embodiment, at least some of the random fibers have a length of up to 30 mm. In yet another embodiment, at least some of the random fibers have a length of up to 40 mm. At least some of the random fibers may also have a length of up to 50 mm. In another embodiment, random fibers are provided in lengths of 10 mm to 500 mm.

Glass fibers and/or carbon fibers can be used as the fibers of the random fiber.

The presented method for producing a structural component of the type described herein provides that a fiber collective with random fibers is first inserted or introduced into a tool and then a plastic material is introduced into the tool. The introduced plastic, which can be introduced by impact extrusion or injection molding, for example, then forms a matrix in the region of the fiber collective. The fiber collective is introduced into or positioned in the tool in such a way that the structural component is reinforced with the fiber collective, which comprises random fibers, in the region of a narrow side of the structural component.

The random fibers introduced can consist of glass fibers and/or carbon fibers, for example.

It is understood that the features mentioned above and those to be explained below can be used not only in the combination indicated in each case, but also in other combinations or on their own, without leaving the scope of the present invention.

Further advantages and embodiments of the invention follow from the description and the accompanying drawing.

### BRIEF DESCRIPTION OF THE DRAWINGS

FIG. 1 shows a perspective view of an embodiment of a structural component.

FIG. 2 shows another embodiment of the structural component.

### EMBODIMENT OF THE INVENTION

The invention is illustrated schematically in the drawing using an embodiment, and is described in detail below with reference to the drawing.

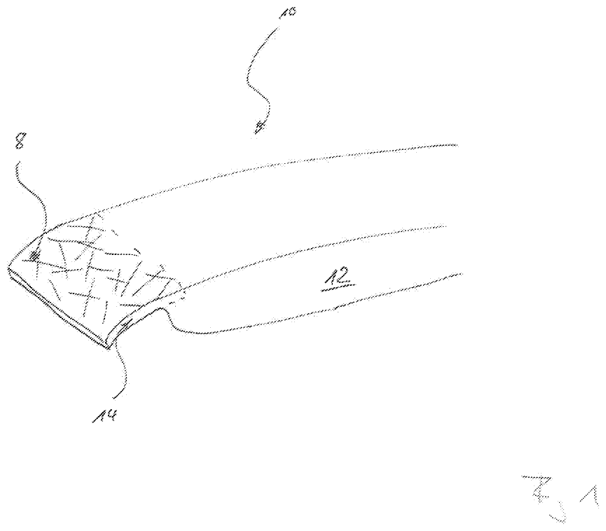

FIG. 1 shows a perspective view of an embodiment of the presented structural component, which is labeled with the reference number 10. This structural component 10 is used in various places in a vehicle, for example, in particular in a motor vehicle.

It can be seen that the structural component 10 has a thick-walled region 12 on the right-hand side and a thin-walled region 14 on the left-hand side, which thin-walled region 14 should be designed to be particularly resistant, since it is located in the edge region of the structural component 10 or represents an extremity of this structural component. However, it is not possible to design this region particularly thick or strong. For this reason, this region 14 is reinforced with fibers of a fiber collective 8, wherein these fibers are in the form of random fibers. Such a fiber collective 8 is also referred to as a random fiber.

The thin-walled region 14 is used for sealing, for example. It should be noted that the fiber collective 8, i.e. the random fibers, can extend into the thick-walled region 12 in order to ensure a stable transition between the thick-walled region 12 and the thin-walled region 14.

The entire structural component 10 can thus be produced with reduced weight at low cost and is nevertheless designed in the critical region 14 in such a way that splintering can be prevented in the event of an external impact.

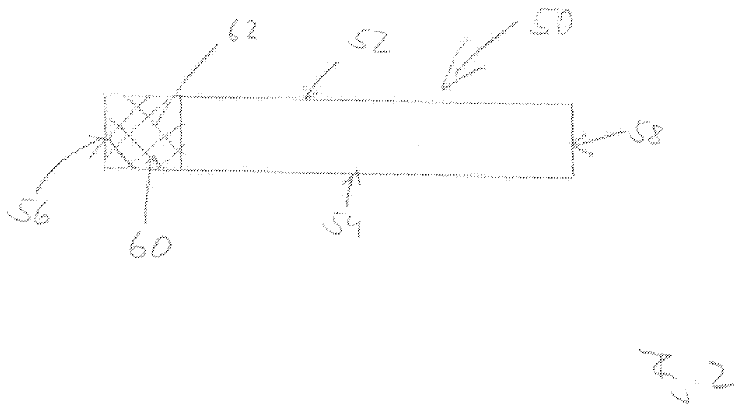

FIG. 2 shows another embodiment of the structural component, which is generally labeled with the reference number 50 and is illustrated purely schematically. The elongated or long structural component 50 has two opposite long sides 52, 54 as well as a first narrow side 56 and a second narrow side 58, which are also opposite each other.

The structural component is now reinforced in the region of the first narrow side 56 with a fiber collective 60, which in turn comprises random fibers 62. Thus, it is not the case that one of the long sides 52 or 54 is reinforced in the manner of a cover layer in order to effect a specific surface of the entire structural component 50 in this way, but only an edge region in the region of the first narrow side 56 is reinforced with random fibers 62. Only in this region are the random fibers 62 provided. In this way, reinforcement is achieved and splintering of the structural component 50 in this region is prevented in the event of mechanical impact.

The reinforcement of the structural component starts from the first narrow side 56 in the direction of the second narrow side 58, largely filling the structural component 50 from the first long side 52 to the second long side 54, wherein approximately ⅕ of the structural component 50 is filled in the longitudinal direction, i.e. from the first narrow side 56 to the second narrow side 58, by the fiber collective 60 with the random fibers 62, at least to a large extent. The extent of this extension in the longitudinal direction depends on the specific application and which region is to be protected. This also applies to the embodiment shown in FIG. 1. Thus the reinforced region can extend also only 1/10 but also up to ¼, ⅓ or even ½ of the total length of the structural component in the longitudinal direction.

When producing the structural component, the fiber collective 60 with the random fibers 62 is first introduced into the tool, then the plastic material is injected or formed by impact extrusion. The plastic of the introduced plastic material then forms a matrix in the region of the fiber collective 60.

The structural component is thus designed in a reinforced manner in a special way on at least one narrow side. The special type of reinforcement ensures that the structural component is stable in this region and that splintering of the structural component is prevented, even in the event of mechanical impairment. The measure shown is thus advantageous in particular for exposed areas of the structural component, as these often come into contact with other components.

1-12. (canceled)

13. A structural component for use in a vehicle, wherein the structural component is made of a plastic material and is reinforced with a fiber collective in the region of a narrow side, wherein the fiber collective comprises random fibers.

14. The structural component according to claim 13, wherein the structural component comprises a thick-walled region and a thin-walled region, wherein the thin-walled region is reinforced with the fiber collective comprising random fibers.

15. The structural component according to claim 13, which is designed for use as a body component of the vehicle.

16. The structural component according to claim 13, wherein at least some of the random fibers have a length of up to 20 mm.

17. The structural component according to claim 13, wherein at least some of the random fibers have a length of up to 30 mm.

18. The structural component according to claim 13, wherein at least some of the random fibers have a length of up to 40 mm.

19. The structural component according to claim 13, wherein at least some of the random fibers have a length of up to 50 mm.

20. The structural component according to claim 13, wherein at least some of the random fibers have lengths in a range from 10 mm to 500 mm.

21. The structural component according to claim 1, wherein at least some of the random fibers consist of glass fibers.

22. The structural component according to claim 13, wherein at least some of the random fibers consist of carbon fibers.

23. A method for producing a structural component, wherein a fiber collective with random fibers is first introduced into a tool and then a plastic material is introduced into the tool.

24. The method according to claim 23, wherein the plastic material is introduced by impact extrusion.
